(19) United States
(12) Patent Application Publication
(10) Pub. No.: US 2024/0402132 A1
(43) Pub. Date: Dec. 5, 2024

(54) COLOR REPRESENTATION OF COMPLEX-VALUED NDT DATA

(71) Applicant: Evident Canada, Inc., Québec (CA)

(72) Inventor: Chi-Hang Kwan, Quebec (CA)

(21) Appl. No.: 18/699,773

(22) PCT Filed: Oct. 18, 2022
(86) PCT No.: PCT/CA2022/051533

§ 371 Date: Apr. 9, 2024

Related U.S. Application Data
(60) Provisional application No. 63/262,842, filed on Oct. 21, 2021.

(51) Int. Cl. G01N 29/06; G06T 11/00

(52) U.S. Cl. CPC G01N 29/0645; G01N 29/0654; G06T 11/001

(57) ABSTRACT

A presentation of data indicative of a non-destructive test (NDT) acquisition can be established as described herein. Establishing such a presentation can include receiving acoustic echo data elicited by respective transmissions of acoustic pulses, transforming the acoustic echo data to obtain a complex-valued representation of the acoustic echo data, the complex-valued representation comprising phase and amplitude data, applying a beamforming technique to the complex-valued representation to obtain magnitude values corresponding to respective pixel or voxel locations in an image, and to obtain data indicative of phase values corresponding to the respective pixel or voxel locations in the image, and assigning color values to the respective pixel or voxel locations using the magnitude values and the phase values, the color values selected from a color space using a respective lightness parameter corresponding to a respective magnitude value and at least one respective hue parameter corresponding to a respective phase value.

### CLAIM OF PRIORITY

This patent application claims the benefit of priority of Chi-Hang Kwan, U.S. Provisional Patent Application Ser. No. 63/262,842, titled “COMPLEX-VALUED DATA REPRESENTATION USING CIE-LAB COLOR SPACE,” filed on Oct. 21, 2021 (Attorney Docket No. 6409.215PRV), which is hereby incorporated by reference herein in its entirety.

### FIELD OF THE DISCLOSURE

This document pertains generally, but not by way of limitation, to manipulation and presentation of non-destructive test data, and more particularly to mapping complex-valued data or a real-valued portion of complex-valued data to a specified color space, such as a CIELAB color space.

### BACKGROUND

Various inspection techniques can be used to image or otherwise analyze structures without damaging such structures. For example, x-ray inspection, eddy current inspection, or acoustic (e.g., ultrasonic) inspection can be used to obtain data for imaging of features on or within a test specimen. Acoustic inspection can be performed using an array of ultrasound transducer elements, such as to image a region of interest within a test specimen. Different imaging modes can be used to present received acoustic signals that have been scattered or reflected by structures on or within the test specimen.

### SUMMARY OF THE DISCLOSURE

Acoustic testing, such as ultrasound-based inspection, can include focusing or beamforming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Such a TFM approach where A-scan data is obtained for each element in an array (or each defined aperture) can be referred to as a “full matrix capture” (FMC) technique.

Generally, imaging generated using TFM beamforming or another beamforming technique can include performing a coherent summation of time-series acoustic echo signal data, such as an analytic representation of such time-series acoustic echo signal data and mapping a magnitude (such as a root-sum-square (RSS)) to a color palette, with different colors representing different magnitude values. The present inventor has recognized that in such an approach, phase information is not displayed contemporaneously with magnitude (or amplitude) data in such a mapping. The present inventor has also recognized that generally available color maps for such magnitude imaging are not perceptually uniform. For example, a “jet” color map, or maps used with generally available TFM magnitude imaging modes of the Omniscan X3 available from Evident Scientific, Inc., Waltham, MA, USA, are not perceptually uniform. Other non-perceptually uniform color maps include “turbo” or “rainbow” (as defined in, for example, https://github.com/matplotlib/matplotlib, published by https://matplotlib.org/). Perceptual uniformity generally refers to a color space having characteristics such that different colors separated by a similar distance in the color space are perceived to be equally different by a user, at least roughly.

The present inventor has developed a technique for generating imaging for presentation, showing a representation of an acoustic acquisition where magnitude and phase information are contemporaneously displayed, such as using a perceptually uniform color space. Such visualization can include applying a beamforming technique to a complex-valued representation of received acoustic echo data signals to obtain magnitude values corresponding to respective pixel or voxel locations in an image, and to obtain data indicative of phase values corresponding to the respective pixel or voxel locations in the image, including assigning color values to the respective pixel or voxel locations using the magnitude values and the phase values, the color values selected from a color space using a respective lightness parameter corresponding to a respective magnitude value and at least one respective hue parameter corresponding to a respective phase value.

The present inventor has also recognized, among things, that use of such color mapping can provide imaging where phase data, such as indicative of a phase change or phase inversion, can allow identification of diffraction effects, such as corresponding to physical features. More generally, use of imaging that encodes phase and amplitude data into a specified color space can allow extraction of information that would otherwise be lost using magnitude-only (or amplitude-only) imaging. For example, both amplitude and phase data resulting from beamforming can be mapped into perceptually uniform color space as described herein. Such imaging can be red-green-blue (RGB) encoded (e.g., pixel values from the perceptually uniform color space can be defined in terms of R, G, and B channel values or re-encoded in such a manner). In this manner, all three channels (red, green, and blue) contain information that is not merely exactly duplicated across channels. Various available machine learning techniques are configured to use RGB-encoded input images. Accordingly, usage of RGB-encoded imaging can be useful for training of such machine-learning techniques or analysis using a machine-learning model trained using such RGB-encoded imaging, and use of RGB-encoded images that map both amplitude and phase data to a specified color space (e.g., a perceptually uniform color space) may facilitate detection of features or performance of other classification in a manner that is more robust than using amplitude-only (e.g., magnitude) images.

In an example, a technique such as a machine-implemented method can be used for establishing a presentation of data indicative of a non-destructive test (NDT) acquisition, the technique comprising receiving acoustic echo data elicited by respective transmissions of acoustic pulses, transforming the acoustic echo data to obtain a complex-valued representation of the acoustic echo data, the complex-valued representation comprising phase and amplitude data, applying a beamforming technique to the complex-valued representation to obtain magnitude values corresponding to respective pixel or voxel locations in an image, and to obtain data indicative of phase values corresponding to the respective pixel or voxel locations in the image, and assigning color values to the respective pixel or voxel locations using the magnitude values and the phase values, the color values selected from a color space using a respective lightness parameter corresponding to a respective magnitude value and at least one respective hue parameter corresponding to a respective phase value.

In an example, a system can be used for establishing a presentation of data indicative of a non-destructive test (NDT) acquisition, the system comprising a processor circuit, a memory circuit, and a communication circuit communicatively coupled with the processor circuit. The memory circuit can include instructions that, when executed by the processor circuit, cause the system to receive acoustic echo data elicited by respective transmissions of acoustic pulses, transform the acoustic echo data to obtain a complex-valued representation of the acoustic echo data, the complex-valued representation comprising phase and amplitude data, apply a beamforming technique to the complex-valued representation to obtain magnitude values corresponding to respective pixel or voxel locations in an image, and to obtain data indicative of phase values corresponding to the respective pixel or voxel locations in the image, and assign color values to the respective pixel or voxel locations using the magnitude values and the phase values, the color values selected from a color space using a respective lightness parameter corresponding to a respective magnitude value and at least one respective hue parameter corresponding to a respective phase value. In the examples mentioned above, the color space can be, for example, a perceptually uniform color space.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A shows an illustrative example of a perceptually uniform color space, such as showing a lightness parameter corresponding to radial position of a color value within the space with respect to the center, and hue corresponding to angular position about the center.

FIG. 2B shows that in the illustrative example of the perceptually uniform color space of FIG. 2A, a constant lightness (e.g., corresponding to a fixed magnitude value) appears as a different hue depending on angular position (e.g., corresponding to a varying phase value).

FIG. 2C shows that in the illustrative example of the perceptually uniform color space of FIG. 2A, a constant angular position (e.g., corresponding to a fixed phase value) appears to have a constant hue, but a different lightness depending on radial position (e.g., corresponding to a varying magnitude value).

FIG. 3 illustrates generally a technique, such as a machine-implemented method for establishing respective parameter values within a color space, such as the perceptually uniform color space shown in the illustrative example of FIG. 2A.

FIG. 4 shows an illustrative example of an amplitude envelope (e.g. magnitude) corresponding to an analytic representation of an acquired acoustic echo signal and a corresponding real-valued time-series representation corresponding to the envelope.

FIG. 5A shows an illustrative example of an image generated by mapping an amplitude envelope of the example of FIG. 4 to a virdis color space along a vertical axis, and sweeping the resulting color mapped time-series representation across a horizontal axis, where phase information corresponding to the oscillation of the real-valued time-series representation is not visible.

FIG. 5B shows an illustrative example of an image generated by mapping a real-valued time-series of the example of FIG. 4 to a virdis color space along a vertical axis and sweeping the resulting color mapped time-series representation across a horizontal axis, where the amplitude envelope is difficult to perceive by a user.

FIG. 5C shows an illustrative example of an image generated to show both magnitude and phase information in a manner that is contemporaneously perceptible, such as using the machine-implemented method of FIG. 3 and the color space of FIG. 2A.

FIG. 6A shows an illustrative example of an image generated using TFM beamforming on a test object having side-drilled holes, the imaging using an amplitude envelope where phase information corresponding to the oscillation of the real-valued time-series representations using for TFM summation is not visible and each pixel corresponds to a greatest magnitude of a TFM summation result for that pixel.

FIG. 6B shows an illustrative example of an image generated using TFM beamforming on the same test object as FIG. 6A but showing phase information by plotting the real-valued component of a TFM summation result corresponding to each pixel.

FIG. 6C shows an illustrative example of an image generated using TFM beamforming on the same test object as FIG. 6A and showing both magnitude and phase information in a manner that is contemporaneously perceptible, such as using the machine-implemented method of FIG. 3 and the color space of FIG. 2A.

FIG. 7 shows an illustrative example of another perceptually uniform color space, such as showing a lightness parameter corresponding to radial position of a color value within the space with respect to the center, and hue corresponding to angular position about the center, but using fewer colors than the example of FIG. 2A.

FIG. 8 illustrates generally a technique, such as a machine-implemented method for establishing respective parameter values within a color space, such as the perceptually uniform color space shown in the illustrative example of FIG. 7.

FIG. 9A and FIG. 9B are images generated using a viridis color space to represent an amplitude envelope and real-valued time-series as in FIG. 5A and FIG. 5B and are provided for comparison with FIG. 9C.

FIG. 9C shows an illustrative example of an image generated to show both magnitude and phase information in a manner that is contemporaneously perceptible, such as using the machine-implemented method of FIG. 8 and the color space of FIG. 7.

FIG. 10A and FIG. 10B are illustrative examples of images generated using TFM beamforming on the test object having side-drilled holes, as in FIG. 6A and FIG. 6B, and are provided for comparison with FIG. 10C.

FIG. 10C shows an illustrative example of an image generated using TFM beamforming on the same test object as FIG. 10A and showing both magnitude and phase information in a manner that is contemporaneously perceptible, such as using the machine-implemented method of FIG. 8 and the color space of FIG. 7.

FIG. 11A shows an illustrative example of an image generated using TFM beamforming, where an amplitude envelope is mapped to a perceptually non-uniform color space.

FIG. 11B shows an illustrative example of an image generated using a phase-based coherent summation technique in a manner similar to regular TFM beamforming, where an amplitude envelope is mapped to a perceptually non-uniform color space.

FIG. 11C shows an illustrative example of an image generated using a phase-based coherent summation technique in a manner similar to regular TFM beamforming, where real component values from a real-valued time-series waveform resulting from summation are used for each pixel value and mapped to a perceptually non-uniform color space.

FIG. 11D shows an illustrative example of an image generated using a phase-based coherent summation technique in a manner similar to regular TFM beamforming, where phase and amplitude values corresponding to a summation result are mapped to a corresponding color within perceptually uniform color space for each pixel, using a machine-implemented method similar to FIG. 8 and the perceptually uniform color space of FIG. 7.

FIG. 12 shows a technique, such as a machine implemented method, for assigning color values to the respective pixel or voxel locations within an image depicting a result of at least one non-destructive test (NDT) acquisition, using magnitude values and phase values obtained using a beamforming technique, the color values selected from a color space using a respective lightness parameter corresponding to a respective magnitude value and at least one respective hue parameter corresponding to a respective phase value.

FIG. 13 illustrates a block diagram of an example comprising a machine upon which any one or more of the techniques (e.g., methodologies) discussed herein may be performed.

### DETAILED DESCRIPTION

Non-destructive testing (NDT) can include use of acoustic techniques for imaging of a surface or interior of a test specimen. Imaging generated from an acoustic acquisition may be subject to interpretation by a user, or such imaging may be analyzed in part using one or more automated techniques. For example, a Total Focusing Method (TFM) beamforming or another beamforming technique can include performing a coherent summation of acquired time-series acoustic echo signal data. Such data can correspond to time-series data from respective receiving elements in an electroacoustic transducer array. For example, in a full-matrix capture (FMC) acquisition, respective transmit elements (or apertures) generate transmit pulses, and echo data is received and digitized for all receive elements (or apertures) for each respective transmission event. In the example of TFM beamforming, a coherent summation is performed for each pixel or voxel location, where delay values or corresponding phase rotation values can be applied based on propagation paths associated with respective transmit and receive element pairs. An extremum such as a magnitude of an analytic representation of the summation can be mapped to a color palette, with different colors representing different magnitude values. The present inventor has recognized that in such an approach, phase information is not displayed contemporaneously with magnitude (or amplitude) data. The present inventor has also recognized that generally available color maps for such magnitude imaging are not perceptually uniform. The apparatus and techniques described herein can provide imaging data from an acoustic inspection that can contemporaneously represent amplitude (e.g., envelope amplitude corresponding to magnitude) and phase data. Use of examples herein involving TFM imaging are merely illustrative, and such techniques are applicable to similar presentation using other acoustic beamforming or acoustic imaging modes. Generally, in the examples herein, a color space can be defined using a polar coordinate system, where phase information corresponds to an angular position in the color space with respect to a central location, and where magnitude information corresponds to a radial distance from a central location. For example, the angular position can correspond to hue, and the radial distance can correspond to lightness.

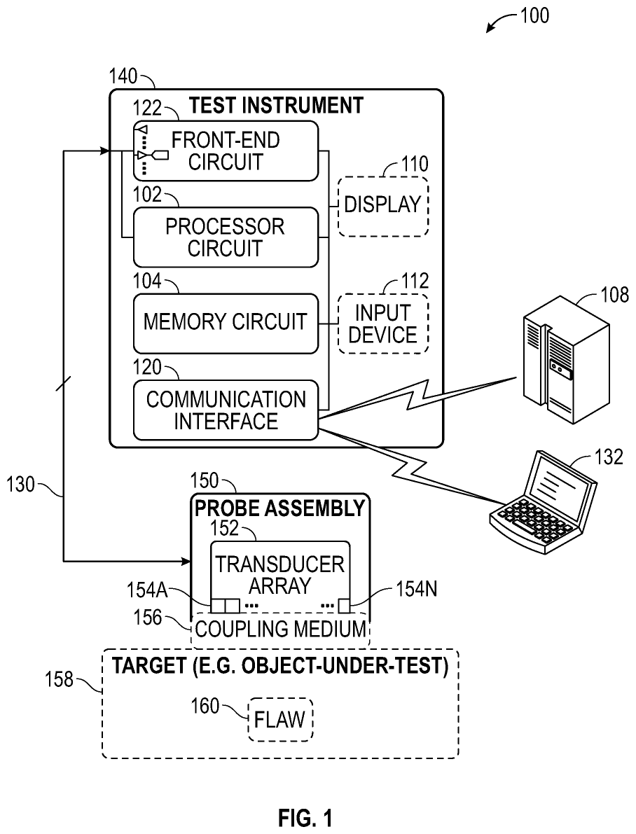

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

As mentioned above, for imaging related to acoustic inspection, amplitude information such as a magnitude or another norm of an analytic signal representation can be used for establishing pixel or voxel values. By contrast, if a real-valued component of a complex-valued analytic signal representation is plotted, such as a real-valued acoustic echo signal waveform, amplitude oscillations can make it difficult to visualize an envelope of the acoustic echo signal (or a coherent summation of such echo signals after beamforming delay laws are applied). The present inventor has recognized, among other things, that amplitude and phase variations can be displayed in a perceptible manner, such as by mapping amplitude and phase values to a color space having a polar representation. For example, such a mapping can include assigning a color value for a pixel or voxel using a respective lightness parameter corresponding to a respective magnitude value and at least one respective hue parameter corresponding to a respective phase value.

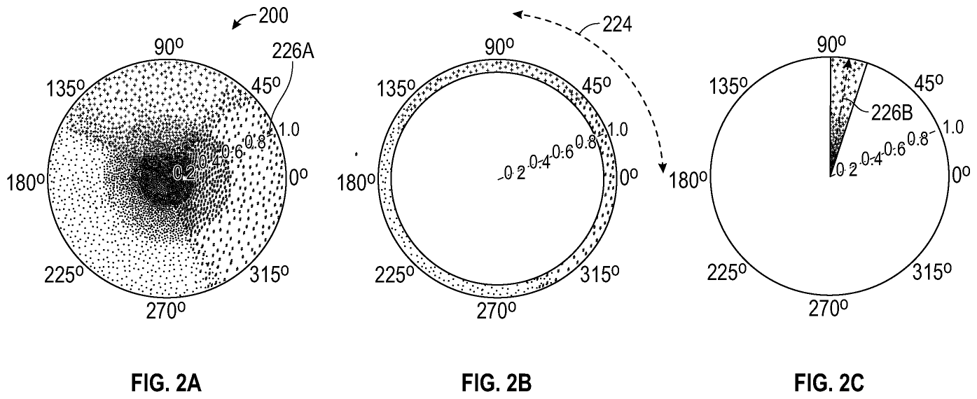

FIG. 2A shows an illustrative example of a perceptually uniform color space 200, such as showing a lightness parameter corresponding to radial position of a color value within the space along any line (such as a line 226A) with respect to the center, and hue corresponding to angular position about the center. The color space shown in FIG. 2A can be referred to as a “CIELAB” or CIE-L*a*b* representation. In such a color space, a lightness parameter, L*, approximates a human perception of lightness, such as defined from a scale of 0 (at the center of the color space 200) to a value of 100 at the outer edge of the line 226A. Color parameters corresponding to hue can be defined as an a* parameter representing red-green cell excitation (e.g., corresponding to variation horizontally across the color space 200), and a b* parameter representing blue-yellow cell excitation (e.g., corresponding to variation vertically across the color space 200). Such a representation can be mapped to complex-valued data by considering the color space in terms of a polar representation, where phase value corresponds to angular position (e.g., hue), and magnitude corresponds to distance from the center of the color space (e.g., lightness). As an illustration, FIG. 2B shows that in the illustrative example of the perceptually uniform color space 200 of FIG. 2A, a constant lightness (e.g., corresponding to a fixed magnitude value) appears as a different hue depending on angular position 224 (e.g., corresponding to a varying phase value). Similarly, FIG. 2C shows that in the illustrative example of the perceptually uniform color space 200 of FIG. 2A, a constant angular position (e.g., at a location 226B corresponding to a fixed phase value) appears to have a constant hue, but a different lightness depending on radial position (e.g., corresponding to a varying magnitude value).

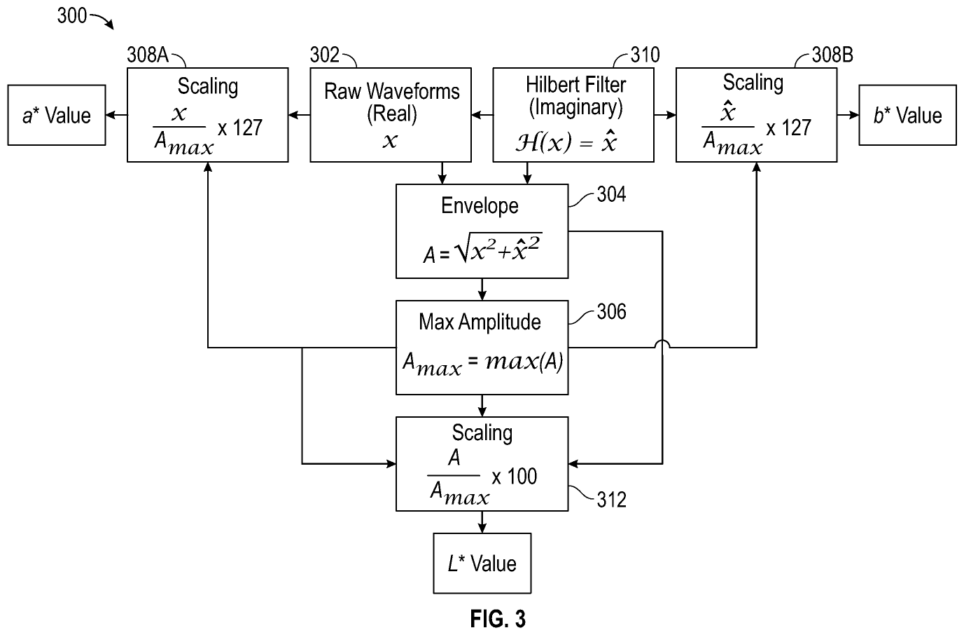

Assignment of values from analytic signal representations to the color space 200 can include assigning a real-valued component as the a* value and an imaginary-valued component as the b* value (or vice versa). For example, the real-valued component and imaginary-valued components can correspond to a location where the amplitude envelope is maximized in TFM or other beamforming summations for a particular pixel or voxel. As an illustration, such as discussed below in relation to FIG. 3, such real-valued and imaginary-valued components can be scaled to normalize all values within a specified range, such as (−127, 127) for each of the a* and b* parameters.

FIG. 3 illustrates generally a technique, such as a machine-implemented method 300 for establishing respective parameter values within a color space, such as the perceptually uniform color space shown in the illustrative example of FIG. 2A. In FIG. 3, raw waveforms x can be received at 302, such as corresponding to digitized representations of acoustic echo signals elicited by one or more acoustic transmission pulses. At 310, a transformation can be applied, such as to provide imaginary-valued waveforms \hat{x} that are phase shifted with respect to the raw real-valued waveforms x. In one approach, a Hilbert transform can be applied, but such an example is illustrative and other approaches can be used, such as a quadrature-based down-conversion approach where in-phase and quadrature components x and \hat{x} are sampled directly or otherwise established.

A combination of the real-valued and imaginary-valued waveforms can be referred to as an analytic representation that is complex-valued. At each point in the complex-valued analytic representation, an envelope value A can be determined at 304. A maximum amplitude Aₘₐₓ can be determined from the envelope values A at 306. Each amplitude envelope value A can be normalized or scaled at 312, such as assigned to a value between 0 and 100. The resulting quotient can be rounded or quantized to provide an integer value as the L* parameter value. At 308A, the Aₘₐₓ value can be used to normalize respective real-valued waveform values x to provide an a* value between −127 and +127. Similarly, at 308B, the Aₘₐₓ value can be used to normalized respective imaginary-valued waveform values \hat{x} to provide a b* bvalue between −127 and +127. For TFM summation, for a particular pixel or voxel location, the raw waveforms x and imaginary-valued waveforms \hat{x} can be phase shifted or delayed and a coherent summation can be performed. A resulting envelope signal A can be determined at 304 for the summation, and the a*, b*, and L* values for the pixel or voxel location can be established as otherwise shown in FIG. 3.

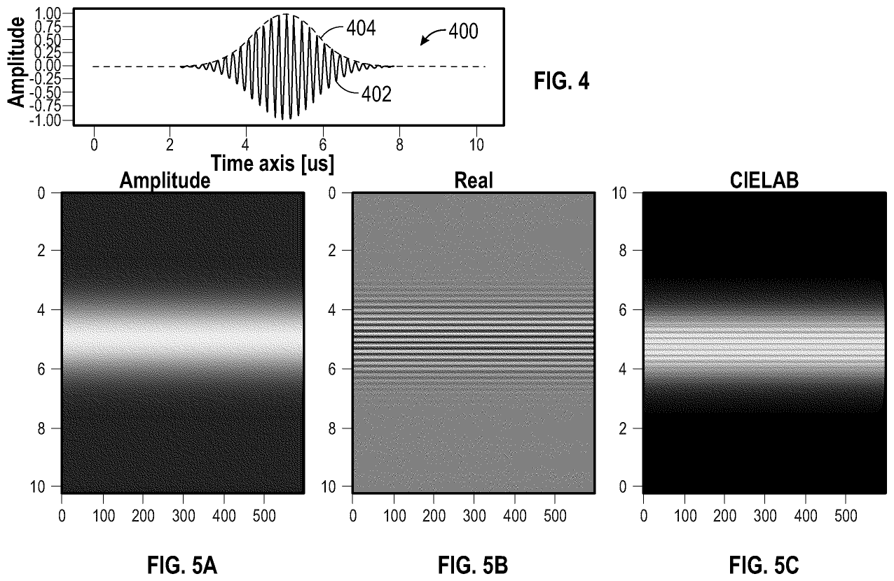

FIG. 4 shows an illustrative example of an amplitude envelope 404 (e.g. magnitude) corresponding to an analytic representation of an acquired acoustic echo signal 400 and a corresponding real-valued time-series 402 representation corresponding to the envelope. The example of FIG. 4 comprises a sinusoidal waveform having a Gaussian envelope and is merely illustrative.

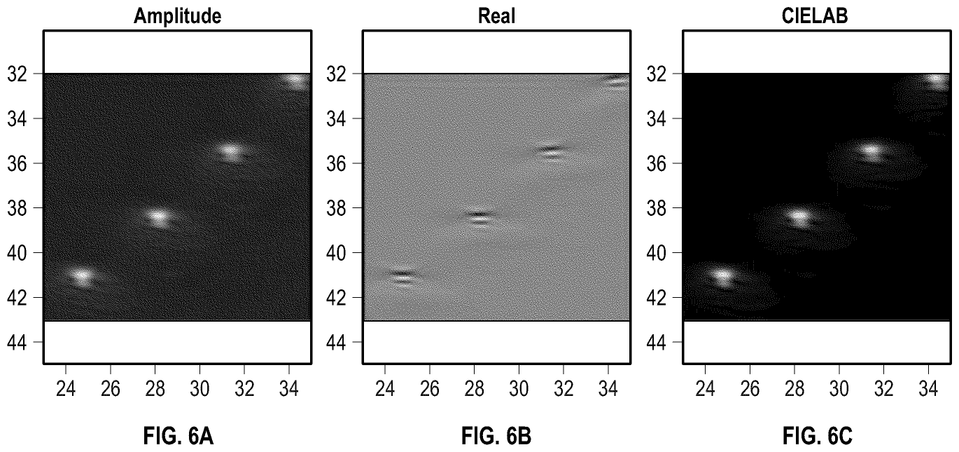

FIG. 5A shows an illustrative example of an image generated by mapping an amplitude envelope of the example of FIG. 4 to a viridis color space along a vertical axis and sweeping the resulting color mapped time-series representation across a horizontal axis, where phase information corresponding to the oscillation of the real-valued time-series representation is not visible. Each location along the horizontal axis can, for example, represent an A-scan acquisition, with each acquisition showing the same waveform in this illustrative example. A lightness profile of the Gaussian envelope is visible in FIG. 5A, but phase oscillation (such as associated with the real-valued time-series 402) of FIG. 4 is not visible.

By contrast, FIG. 5B shows an illustrative example of an image generated by mapping the real-valued time-series 402 of the example of FIG. 4 to a viridis color space along a vertical axis and sweeping the resulting color mapped time-series representation across a horizontal axis. In FIG. 5B, oscillation is visible, but the viridis color mapping using only the amplitude of the real-valued time-series 402 obscures perception of the Gaussian profile. In this manner, presentation of a time-series waveform may obscure perception by a user of the envelope of received echoes (e.g., corresponding the illustrative example of an envelope 404 of the waveform of FIG. 4).

FIG. 5C shows an illustrative example of an image generated to show both magnitude and phase information in a manner that is contemporaneously perceptible, such as using the machine-implemented method of FIG. 3 and the color space of FIG. 2A (e.g., a CIELAB color space). In the example of FIG. 5C, because both amplitude and phase data are used for color assignment, oscillation associated with phase variation is visible, and an amplitude envelope is also visible contemporaneously with the phase variation.

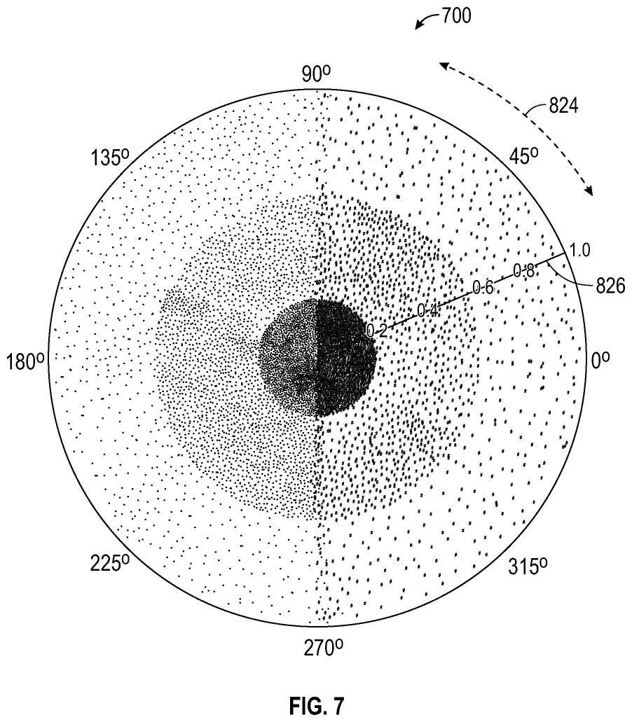

FIG. 6A shows an illustrative example of an image generated using TFM beamforming on a test object having side-drilled holes, the imaging using an amplitude envelope where phase information corresponding to the oscillation of the real-valued time-series representations using for TFM summation is not visible and each pixel corresponds to a greatest magnitude of a TFM summation result for that pixel. Even though the color space used for FIG. 6A is a perceptually uniform viridis color space, the technique for generating the image in FIG. 6A does not use amplitude and phase data independently to assign a color value to each pixel. Similarly, FIG. 6B shows an illustrative example of an image generated using TFM beamforming on the same test object as FIG. 6A but showing phase information by plotting the real-valued component of a TFM summation result corresponding to each pixel. Again, the color space used for FIG. 6B is a perceptually uniform viridis color space. As in the example of FIG. 5B, amplitude envelope features are difficult to discern in FIG. 6B, though phase oscillation is highly visible.

FIG. 6C shows an illustrative example of an image generated using TFM beamforming on the same test object as FIG. 6A and showing both magnitude and phase information in a manner that is contemporaneously perceptible, such as using the machine-implemented method of FIG. 3 and the color space of FIG. 2A. in FIG. 6C, phase oscillation and magnitude information are both perceptible. If TFM or other acoustic inspection imaging were presented using the CIELAB color space as shown in FIG. 6C, a color circle similar to FIG. 2A could be included as a legend, instead of magnitude color bar, to show how respective phase and amplitude pairs map to respective colors. As mentioned above, such a color assignment can effectively “colorize” both amplitude and phase information, such as for use in training or applying machine learning models, because such models may employ image processing networks that take RGB-encoded image data as an input).

To simplify image interpretation for end users, the color space of FIG. 2A (with two separate color parameters corresponding to red-green and blue-yellow excitation) may be further simplified, while still providing a technique for contemporaneous presentation of amplitude and phase information. For example, in the CIELAB space, one of the two color parameters a* or b* can be set to a constant, such as set to zero, or otherwise disregarded.

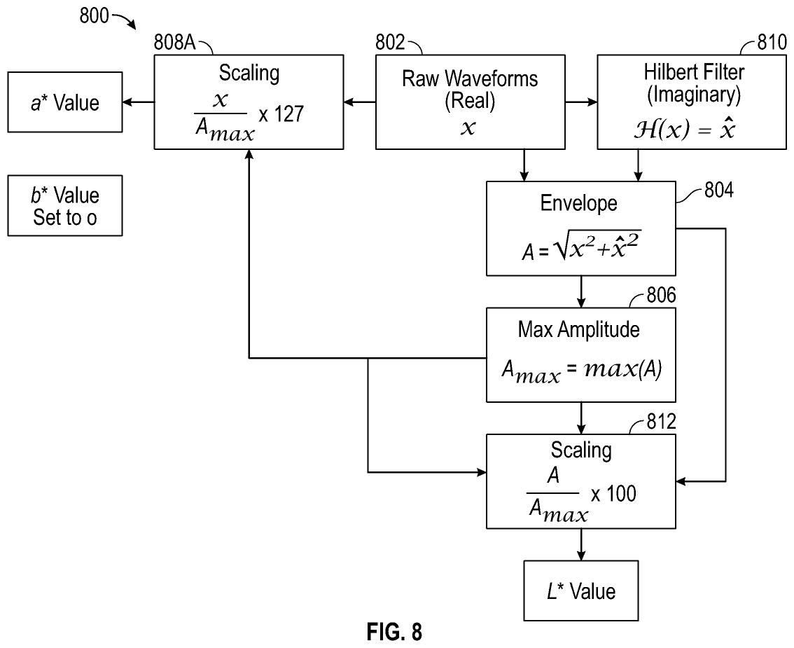

FIG. 7 shows an illustrative example of another perceptually uniform color space 700 that is simplified as compared to the color space 200 of FIG. 2A. In FIG. 7, the color space 700 shows a lightness parameter corresponding to radial position of a color value within the space with respect to the center (such as along a line 826 showing lightness values from a scale of 0 to 1.0, corresponding to L* parameters from 0 to 100), and hue corresponding to angular position 824 about the center, but using fewer colors than the example of FIG. 2A.

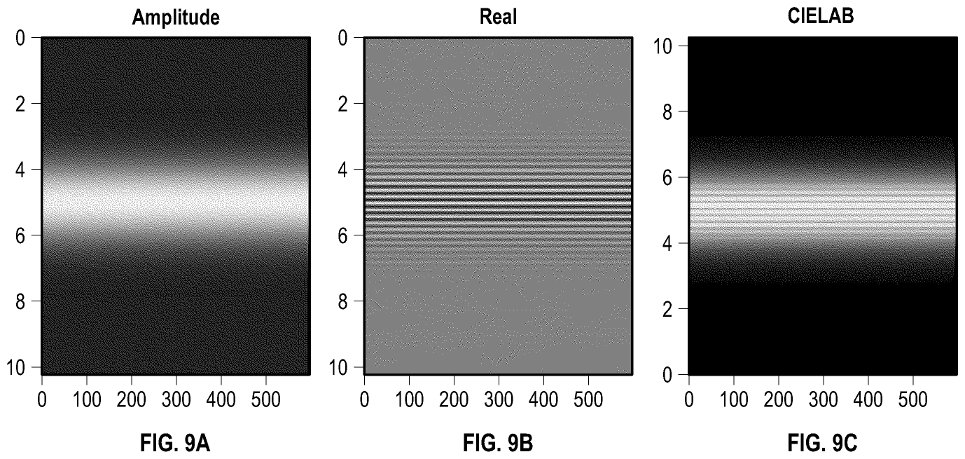

FIG. 8 illustrates generally a technique, such as a machine-implemented method 800 for establishing respective parameter values within a color space, such as the perceptually uniform color space shown in the illustrative example of FIG. 7. The machine-implemented method 800 is similar to the machine-implemented method 300 of FIG. 3 but simplified. At 802, raw waveforms x can be received. At 810, a transformation can be applied, such as to provide imaginary-valued waveforms \hat{x} that are phase shifted with respect to the raw real-valued waveforms x. As in FIG. 3, a combination of the real-valued and imaginary-valued waveforms can be referred to as an analytic representation that is complex-valued. At each point in the complex-valued analytic representation, an envelope value A can be determined at 804. A maximum amplitude Aₘₐₓ, can be determined from the envelope values A at 806. Each amplitude envelope value A can be normalized or scaled at 812, such as assigned to a value between 0 and 100. The resulting quotient can be rounded or quantized to provide an integer value as the L* parameter value. At 808A, the Aₘₐₓ value can be used to normalize respective real-valued waveform values x to provide an a* value between −127 and +127. Unlike FIG. 3, the b* can be set to zero. The example of FIG. 8 is merely illustrative, and the b* values could be non-zero, with the a* value set to zero, as another implementation.

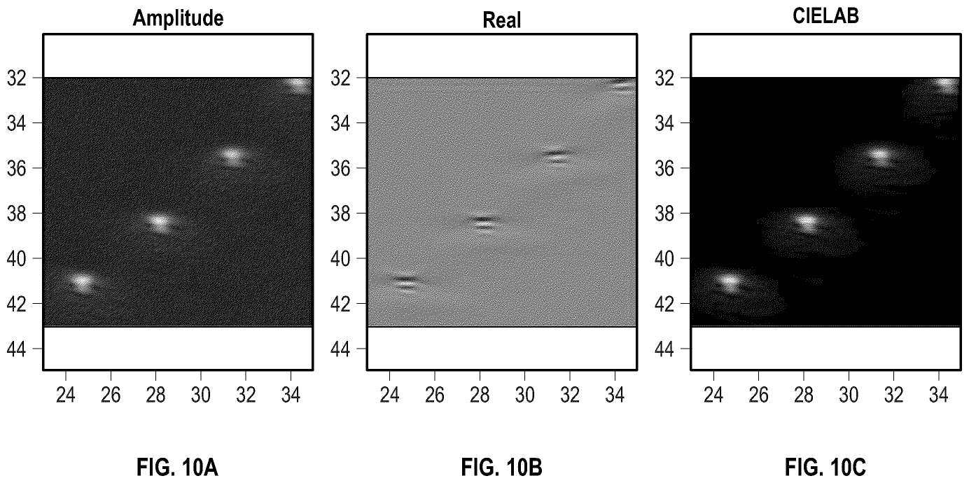

FIG. 9A and FIG. 9B are images generated using a viridis color space to represent an amplitude envelope and real-valued time-series as in FIG. 5A and FIG. 5B and are provided for comparison with FIG. 9C, and FIG. 9C shows an illustrative example of an image generated to show both magnitude and phase information in a manner that is contemporaneously perceptible, such as using the machine-implemented method of FIG. 8 and the color space 700 of FIG. 7. Like the example of FIG. 5C, an amplitude envelope and oscillation are both visible, but fewer different hues are used, providing a simpler representation than the color space 200 of FIG. 2.

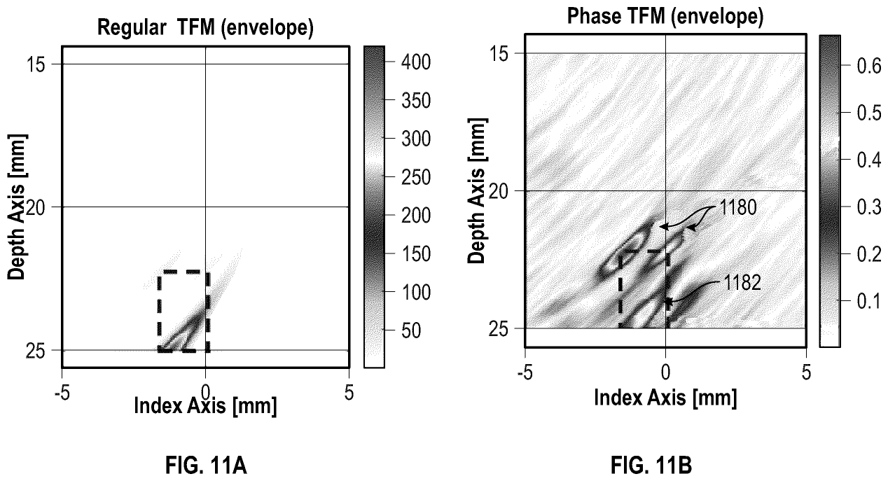

FIG. 10A and FIG. 10B are illustrative examples of images generated using TFM beamforming on the test object having side-drilled holes, as in FIG. 6A and FIG. 6B, and are provided for comparison with FIG. 10C, and FIG. 10C shows an illustrative example of an image generated using TFM beamforming on the same test object as FIG. 10A and showing both magnitude and phase information in a manner that is contemporaneously perceptible, such as using the machine-implemented method of FIG. 8 and the color space 700 of FIG. 7. Again, like the example of FIG. 6C, an amplitude envelope and oscillation are both visible, but fewer different hues are used, providing a simpler representation than the color space 200 of FIG. 2.

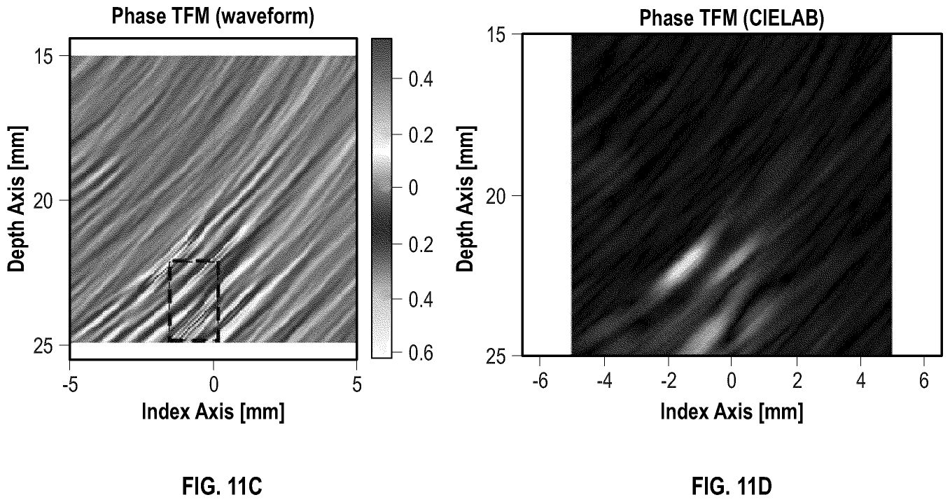

FIG. 11A shows an illustrative example of an image generated using TFM beamforming, where an amplitude envelope is mapped to a perceptually non-uniform color space. The data for FIG. 11A were obtained by inspection of a test object having a rectangular notch 3 millimeters (mm) deep and 1.5 mm wide at the bottom edge of a steel block. A dashed line is used to annotate the image to show a rough outline of the defect location in the test specimen. The amplitude envelope shown in FIG. 11A clearly shows a corner-trapped echo (in the lower left-hand region of the dashed outline. In the example of FIG. 11A, tip-diffracted echoes are not clearly visible.

FIG. 11B shows an illustrative example of an image generated using a phase-based coherent summation technique in a manner similar to regular TFM beamforming, where an amplitude envelope is mapped to a perceptually non-uniform color space. In the example of FIG. 11B, a phase-based approach (such as shown and described in WIPO patent application publication WO2021168565A1) can be used to show tip-diffracted echo features 1180 in addition to a corner-trapped echo feature 1182. Even though the imaging in FIG. 11B is referred to as “phase-based,” individual pixels are generated using a magnitude of a coherent summation of individual echo waveform contributions. In such an approach, raw echo data is binarized or otherwise encoded in such a manner to capture phase transitions without requiring digitization at full amplitude and time resolution. The image of FIG. 11C does show phase-inversion for the echoes at the upper portion of the defect (e.g., red-green-red and green-red-green), which is indicative of diffracted echoes at opposing tips of the defect. However, the image is otherwise relatively cluttered, and may be difficult to interpret without prior knowledge of the test sample and defect geometry.

In yet another example, FIG. 11C shows an illustrative example of an image generated using a phase-based coherent summation technique in a manner similar to regular TFM beamforming, where real component values from a real-valued time-series waveform resulting from summation are used for each pixel value and mapped to a perceptually non-uniform color space.

FIG. 11D shows an illustrative example of an image generated using a phase-based coherent summation technique in a manner similar to regular TFM beamforming, where phase and amplitude values corresponding to a summation result are mapped to a corresponding color within perceptually uniform color space for each pixel, using a machine-implemented method similar to FIG. 8 and the perceptually uniform color space 700 of FIG. 7. In FIG. 11D, by contrast with FIG. 11A, FIG. 11B, and FIG. 11C, a phase-based coherent summation approach is used, but instead of plotting magnitude values, an analytic representation of each coherent summation is used, where an amplitude corresponding to the maximum magnitude of the analytic representation, and a corresponding phase value, are assigned to a color value. In FIG. 11D, amplitude envelope and phase oscillation are both visible contemporaneously (where the amplitude envelope is shown by lightness variation, and the phase variation is shown by green-to-red or red-to-green color oscillation).

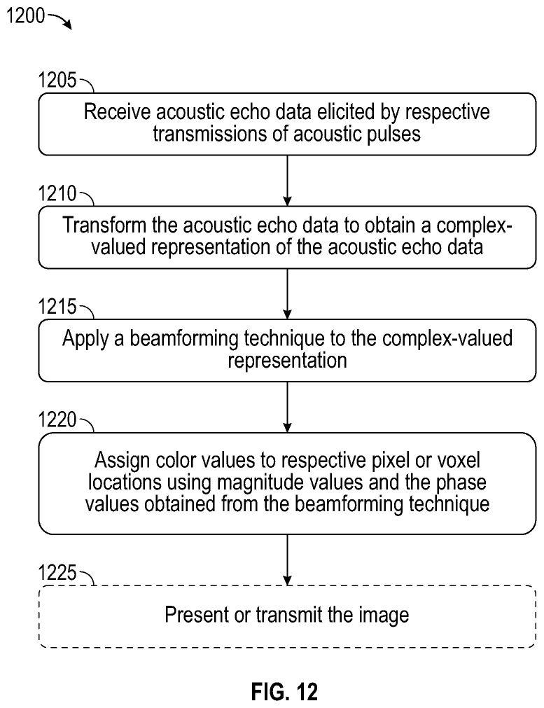

FIG. 12 shows a technique, such as a machine implemented method 1200, for assigning color values to the respective pixel or voxel locations within an image depicting a result of at least one non-destructive test (NDT) acquisition, using magnitude values and phase values obtained using a beamforming technique, the color values selected from a color space using a respective lightness parameter corresponding to a respective magnitude value and at least one respective hue parameter corresponding to a respective phase value. In FIG. 12, at 1205, acoustic echo data can be received, the acoustic echo data elicited by respective transmissions of acoustic pulses. For example, the acoustic echo data received at 1205 can be digitized time-series data acquired in relation to a full matrix capture (FMC) acquisition. At 1210, the acoustic echo data can be transformed to obtain a complex-valued (e.g., analytic) representation of the acoustic echo data. The complex-valued representation can include a real-valued component and an imaginary-valued component. At 1215, a beamforming technique can be applied to the complex-valued representation. Such beamforming can include performing TFM beamforming or another approach. The beamforming can generate magnitude values corresponding to respective pixel or voxel locations in an image, and data indicative of phase values corresponding to the respective pixel or voxel locations in the image. At 1120, color values can be assigned to the respective pixel or voxel locations using the magnitude and phase values determined at 1215. For example, the color values can be selected from a color space (e.g., a color space 200 as shown in FIG. 2A or a color space 700 as shown in FIG. 7) using a respective lightness parameter (e.g., L*) corresponding to a respective magnitude value, and at least one respective hue parameter (e.g., a* or b*, or both) corresponding to a respective phase value. Optionally, at 1225, a resulting image can be transmitted for presentation to a user, or presented to a user, such as upon a test instrument used for performing non-destructive testing.

As mentioned generally above, the color assignment and relating imaging described herein may be useful for training or applying machine learning (e.g., deep learning) approaches, such as for assisting in automatic characterization of imaging. For example, flaw detection could be performed using an image feature detection network trained using colorized imaging as described herein. For such an application, B-scan, C-scan, or TFM imaging can be processed by a convolutional neural network that was otherwise established for processing natural images. As illustrative examples, feature detection networks such as Faster-RCNN (https://arxiv.org/abs/1506.01497) and YOLO v4 (https://arxiv.org/abs/2004.10934) generally receive three-channel RGB-encoded images as inputs. In the absence of the techniques described herein, use of such feature detection networks may not perform properly if applied to acoustic inspection data because such data is not intrinsically associated with color information. In one approach, the same luminance-encoded imaging data could be repeated (e.g., duplicated) in all three of the input color channels to obtain a gray-scale image. However, doing so without modifying the feature detection network would be wasteful for memory usage (since all color channels contain duplicate information). Such an approach would also likely nullify any color differentiation ability of a feature detection network expecting different information in each of the three channels. By contrast, as described herein, acoustic inspection data can be “colorized.” By using the techniques herein, such as using the CIE-LAB color space, both amplitude and phase information can be encoded contemporaneously in a single image, facilitating use of natural image oriented feature detection techniques.

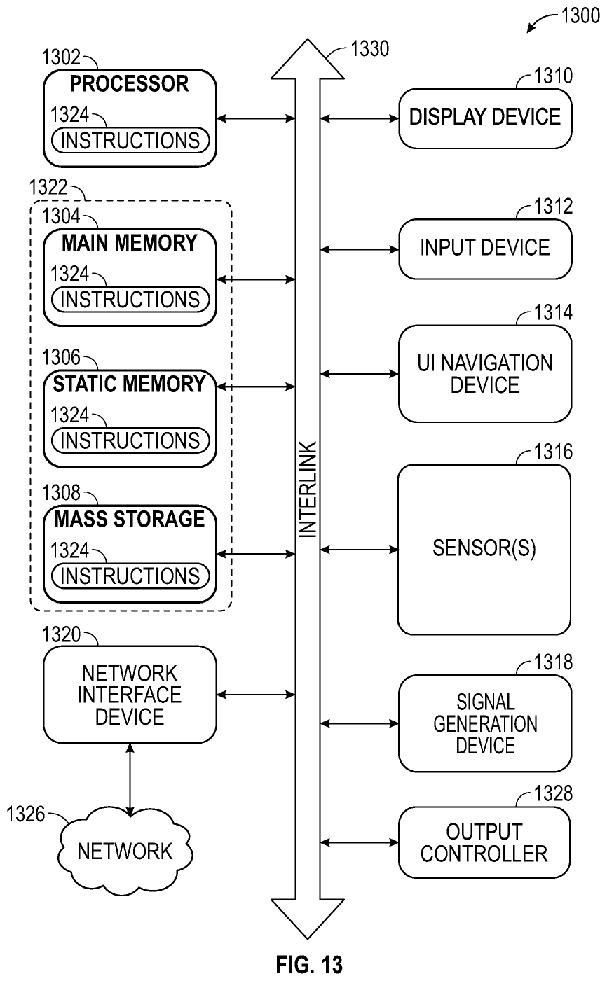

FIG. 13 illustrates a block diagram of an example comprising a machine 1300 upon which any one or more of the techniques (e.g., methodologies) discussed herein may be performed. Machine 1300 (e.g., computer system) may include a hardware processor 1302 (e.g., a central processing unit (CPU), a graphics processing unit (GPU), a hardware processor core, or any combination thereof), a main memory 1304 and a static memory 1306, connected via an interlink 1330 (e.g., link or bus), as some or all of these components may constitute hardware for systems or related implementations discussed above.

Specific examples of main memory 1304 include Random Access Memory (RAM), and semiconductor memory devices, which may include storage locations in semiconductors such as registers. Specific examples of static memory 1306 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 1300 may further include a display device 1310, an input device 1312 (e.g., a keyboard), and a user interface (UI) navigation device 1314 (e.g., a mouse). In an example, the display device 1310, input device 1312, and UI navigation device 1314 may be a touch-screen display. The machine 1300 may include a mass storage device 1308 (e.g., drive unit), a signal generation device 1318 (e.g., a speaker), a network interface device 1320, and one or more sensors 1316, such as a global positioning system (GPS) sensor, compass, accelerometer, or some other sensor. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 1308 may comprise a machine-readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the mass storage device 1308 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 1324.

An apparatus of the machine 1300 includes one or more of a hardware processor 1302 (e.g., a central processing unit (CPU), a graphics processing unit (GPU), a hardware processor core, or any combination thereof), a main memory 1304 and a static memory 1306, sensors 1316, network interface device 1320, antennas, a display device 1310, an input device 1312, a UI navigation device 1314, a mass storage device 1308, instructions 1324, a signal generation device 1318, or an output controller 1328. The apparatus may be configured to perform one or more of the methods or operations disclosed herein.

The term “machine readable medium” includes, for example, any medium that is capable of storing, encoding, or carrying instructions for execution by the machine 1300 and that cause the machine 1300 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 1324 may be transmitted or received, for example, over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 1320 includes one or more physical jacks (e.g., Ethernet, coaxial, or other interconnection) or one or more antennas to access the communications network 1326. In an example, the network interface device 1320 includes one or more antennas to wirelessly communicate using at least one of single-input multiple-output (SIMO), multiple-input multiple-output (MIMO), or multiple-input single-output (MISO) techniques. In some examples, the network interface device 1320 wirelessly communicates using Multiple User MIMO techniques. The term “transmission medium” shall be taken to include any intangible medium that is capable of storing, encoding or carrying instructions for execution by the machine 1300, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for establishing a presentation of data indicative of a non-destructive test (NDT) acquisition, the method comprising:
receiving acoustic echo data elicited by respective transmissions of acoustic pulses;
transforming the acoustic echo data to obtain a complex-valued representation of the acoustic echo data, the complex-valued representation comprising phase and amplitude data;
applying a beamforming technique to the complex-valued representation to obtain magnitude values corresponding to respective pixel or voxel locations in an image, and to obtain data indicative of phase values corresponding to the respective pixel or voxel locations in the image; and
assigning color values to the respective pixel or voxel locations using the magnitude values and the phase values, the color values selected from a color space using a respective lightness parameter corresponding to a respective magnitude value and at least one respective hue parameter corresponding to a respective phase value.

2. The machine-implemented method of claim 1, wherein the color space comprises a perceptually uniform color space.

3. The machine-implemented method of claim 2, wherein the perceptually uniform color space comprises a CIE-LAB color space;
wherein the respective lightness parameter corresponds to an L* parameter; and
wherein the at least one respective hue parameter corresponds to at least one of an a* parameter or a b* parameter.

4. The machine-implemented method of claim 3, wherein one of the a* parameter or the b* parameter comprises a real-valued component of complex-valued representation, and a remaining one of the a* parameter or the b* parameter comprises an imaginary-valued component of the complex-valued representation.

5. The method of claim 4, wherein the magnitude values are normalized to encompass a specified range of lightness parameters; and
wherein real-valued components and imaginary-valued components are normalized to encompass a specified range of a* parameter values and a specified range of b* parameter values.

6. The machine-implemented method of claim 3, wherein the at least one respective hue parameter comprises one of the a* parameter or the b* parameter, corresponding to a real-valued component of the complex-valued representation, and a remaining one of the a* parameter or the b* parameter is set to a specified constant or disregarded.

7.-8. (canceled)

9. The machine-implemented method of claim 1, wherein the beamforming technique comprises one of a Total Focusing Method (TFM) beamforming technique or a phase-based coherent summation technique.

10. (canceled)

11. The machine-implemented method of claim 1, comprising presenting the image to a user or transmitting the image for presentation to the user.

12. The machine-implemented method of claim 1, wherein respective pixels or respective voxels in the image illustrate magnitude variation as variation in lightness and phase variation as variation in hue.

13. A system for establishing a presentation of data indicative of a non-destructive test (NDT) acquisition, the system comprising:
a processor circuit;
a memory circuit; and
a communication circuit communicatively coupled with the processor circuit;
wherein the memory circuit comprises instructions that, when executed by the processor circuit, cause the system to:
receive acoustic echo data elicited by respective transmissions of acoustic pulses;
transform the acoustic echo data to obtain a complex-valued representation of the acoustic echo data, the complex-valued representation comprising phase and amplitude data;
apply a beamforming technique to the complex-valued representation to obtain magnitude values corresponding to respective pixel or voxel locations in an image, and to obtain data indicative of phase values corresponding to the respective pixel or voxel locations in the image; and
assign color values to the respective pixel or voxel locations using the magnitude values and the phase values, the color values selected from a color space using a respective lightness parameter corresponding to a respective magnitude value and at least one respective hue parameter corresponding to a respective phase value.

14. The system of claim 13, comprising a display; and
wherein the instructions, when executed by the processor circuit, cause the system to present the image using the display.

15. The system of claim 14, comprising:
a multi-element electroacoustic transducer array; and
an analog front end coupled with the multi-element electroacoustic transducer array, the analog front end configured to digitize acoustic echoes to provide the acoustic echo data; and
wherein the display is included as a portion of an instrument housing the processor circuit and memory circuit, separate from a test probe assembly housing the multi-element electroacoustic transducer array.

16. The system of claim 14, wherein the color space comprises a perceptually uniform color space.

17. The system of claim 16, wherein the perceptually uniform color space comprises a CIE-LAB color space;
wherein the respective lightness parameter corresponds to an L* parameter; and
wherein the at least one respective hue parameter corresponds to at least one of an a* parameter or a b* parameter.

18. The system of claim 17, wherein one of the a* parameter or the b* parameter comprises a real-valued component of the complex-valued representation, and a remaining one of the a* parameter or the b* parameter comprises an imaginary-valued component of the complex-valued representation.

19. The system of claim 18, wherein the instructions, when executed by the processor circuit, cause the system to:
normalize magnitude values to encompass a specified range of lightness parameters; and
normalize real-valued components and normalize imaginary-valued components to encompass a specified range of a* parameter values and a specified range of b* parameter values.

20. The system of claim 17, wherein the at least one respective hue parameter comprises one of the a* parameter or the b* parameter, corresponding to a real-valued component of the complex-valued representation; and
wherein the instructions, when executed by the processor circuit, cause the system to set a remaining one of the a* parameter or the b* parameter to a constant or to disregard the remaining one of the a* parameter or the b* parameter.

21. (canceled)
